(19) United States
(12) Patent Application Publication
(10) Pub. No.: US 2026/0152838 A1
(43) Pub. Date: Jun. 4, 2026

(54) OXIDIZED AND BORONIZED LAYERS FOR CORROSION RESISTANCE

(71) Applicant: GM GLOBAL TECHNOLOGY OPERATIONS LLC, Detroit, MI (US)

(72) Inventors: Benjamin Everest Slattery, Tecumseh (CA); Cara Lynn Learman, Linden, MI (US); Kevin P. Callaghan, Bloomfield Hills, MI (US)

(73) Assignee: GM GLOBAL TECHNOLOGY OPERATIONS LLC, Detroit, MI (US)

(21) Appl. No.: 18/968,824

(22) Filed: Dec. 4, 2024

(51) Int. Cl. C23C 8/70; C23C 8/02; C23C 8/18; F16D 65/00; F16D 65/02; F16D 65/12

(52) U.S. Cl. CPC C23C 8/70; C23C 8/02; C23C 8/18; F16D 65/0025; F16D 65/125; F16D 65/127; F16D 2065/132; F16D 2200/0008; F16D 2200/0017; F16D 2200/0078; F16D 2250/0007; F16D 2250/0046

(57) ABSTRACT

Corrosion resistance brake rotors, vehicle with such brake rotors, and methods for forming corrosion resistant products are provided. A method includes boronizing a surface of a ferrous metal component to form an iron boride layer on the surface; and steam treating the ferrous metal component to form an iron oxide layer on the iron boride layer.

### INTRODUCTION

The technical field generally relates to wear and corrosion resistant layers and methods for forming wear and corrosion resistant layers, and more particularly to such layers on brake rotors used in vehicles.

Vehicle brakes utilize friction to stop the wheels from turning and bring the vehicle to a halt. As the brake pedal is depressed or the brake is otherwise actuated, hydraulic pressure is applied to one or more brake pads associated with a given wheel. The brake pads are pressed against a rotor connected to each wheel, causing the rotation of the wheel to slow and eventually halt. During this process, kinetic energy is converted to heat energy, which may result in relatively high local temperatures on the rotor. The contact between the brake pads and the rotor causes material loss in both the brake pads and the rotor, and formation of particulates. Depending on the composition, as some rotors wear, they create track patterns or grooves in the pad or rotor.

Accordingly, it is desirable to provide wear and corrosion resistant layers on brake rotors, and methods for manufacturing such wear and corrosion resistant layers. Furthermore, other desirable features and characteristics of the present disclosure will become apparent from the subsequent detailed description and the appended claims, taken in conjunction with the accompanying drawings and the foregoing introduction.

### SUMMARY

In one embodiment, a method for forming a corrosion resistant product includes boronizing a surface of a ferrous metal component to form an iron boride layer on the surface; and steam treating the ferrous metal component to form an iron oxide layer on the iron boride layer.

In certain embodiments, the method further includes casting the ferrous metal component from a molten material to form a ferrous casting; machining the ferrous casting to form a machined casting; and removing contamination from the machined casting before boronizing the surface.

In certain embodiments of the method, boronizing includes contacting the ferrous metal component with a boron containing composition, and the ferrous metal component is exposed to a temperature of from 700° C. to 1000° C.

In certain embodiments of the method, steam treating is performed immediately after boronizing such that the ferrous metal component retains residual heat from the boronizing and is at a temperature of at least 200° C. when beginning the stream treating.

In certain embodiments, the method further includes controlling boronizing conditions to minimize formation of iron monoboride (FeB) and promote formation of diiron boride (Fe₂B).

In certain embodiments, the method further includes mechanically finishing the surface after boronizing.

In certain embodiments of the method, the iron boride layer includes iron monoboride (FeB) phases; and mechanically finishing includes removing the iron monoboride (FeB) phases from the surface.

In certain embodiments of the method, steam treating the ferrous metal component to form the iron oxide layer on the iron boride layer includes heating the ferrous metal component with gaseous steam to a selected temperature of from 315° C. to 540° C. for a duration of from 0.5 to 3 hours.

In certain embodiments of the method, the iron boride layer is formed with a thickness of from 0.02 millimeters to 2.5 millimeters, and the iron oxide layer is formed with a thickness of from 10 microns to 50 microns.

In another embodiment, a brake rotor includes a ferrous metal body; an iron boride layer on the ferrous metal body; and an iron oxide layer on the iron boride layer, and the iron oxide layer forms a corrosion-resistant braking surface.

In certain embodiments of the brake rotor, the iron oxide layer is a magnetite oxide layer.

In certain embodiments of the brake rotor, the iron oxide layer has a thickness of from 10 to 50 microns.

In certain embodiments of the brake rotor, the iron oxide layer has a thickness of from 20 to 30 microns.

In certain embodiments of the brake rotor, the iron boride layer includes a layer of diiron boride (Fe₂B) phases.

In certain embodiments of the brake rotor, the iron boride layer includes diiron boride (Fe₂B) phases and iron monoboride (FeB) phases.

In certain embodiments of the brake rotor, the iron boride layer consists of diiron boride (Fe₂B) phases.

In certain embodiments of the brake rotor, the iron boride layer has a thickness of from 0.02 to 2.5 millimeters.

In another embodiment, a vehicle includes a propulsion system configured to provide motive torque to wheels; and a braking system for braking rotation of the wheels, the braking system includes a brake rotor, and the brake rotor includes: a ferrous metal body having an outer surface; an iron boride layer formed on the outer surface of the ferrous metal body, the iron boride layer includes diiron boride (Fe₂B) phases, and the iron boride layer has a thickness of from 0.02 millimeters to 2.5 millimeters, an oxide layer formed on the iron boride layer, the oxide layer is a magnetite oxide layer, the iron boride layer has a thickness of from 10 microns to 50 microns; and the iron oxide layer forms a corrosion-resistant braking surface.

In certain embodiments of the vehicle, the iron boride layer consists of Fe₂B phases.

In certain embodiments of the vehicle, the iron boride layer includes the diiron boride (Fe₂B) phases and iron monoboride (FeB) phases.

### DESCRIPTION OF THE DRAWINGS

The present disclosure will hereinafter be described in conjunction with the following drawing figures, wherein like numerals denote like elements, and wherein:

FIG. 1 is a schematic illustration of a vehicle including a brake system according to an embodiment of the present disclosure.

FIG. 2 is an illustration of a disc rotor of the brake system of FIG. 1 according to an embodiment of the present disclosure.

FIG. 3 is an illustration of a disc rotor of the brake system of FIG. 1 according to an embodiment of the present disclosure.

FIG. 4 is an illustration of a drum rotor of the brake system of FIG. 1 according to an embodiment of the present disclosure.

FIG. 5 is an illustration of a cross-section of a boronized surface according to an embodiment of the present disclosure.

FIG. 6 is an illustration of a cross-section of an oxidized and boronized surface according to an embodiment of the present disclosure.

FIG. 7 is a flowchart of a method of boronizing and oxidizing a surface of a product, such as a braking surface of a brake rotor, according to an embodiment of the present disclosure.

### DETAILED DESCRIPTION

The following description is merely exemplary in nature and is not intended to limit the present disclosure, application, or uses. Furthermore, there is no intention to be bound by any expressed or implied theory present in the preceding introduction, summary, or the following detailed description. It should be understood that through the drawings, corresponding reference numerals indicate like or corresponding parts and features.

While the present technology is described primarily herein in connection with passenger vehicles, the technology is not limited to passenger vehicles. The concepts can be used in a wide variety of applications, such as in connection with commercial vehicles, off-highway vehicles, military vehicles, motorcycles, mopeds, locomotives, aircraft, marine craft, and other vehicles, as well as in other applications where disc rotors may be incorporated, such as in industrial applications including conveyors, indexers, wind turbines, and hose reels. For example, any ferrous metal product may be processed according to methods herein as described.

The present disclosure is directed to oxidized and boronized brake rotors, oxidized and boronized brake rotor systems, and methods of boronizing and oxidizing the brake rotors.

Aspects of the present disclosure provide methods for manufacturing an enhanced vehicular brake rotor having improved wear and corrosion resistance. The methods involve first boronizing an outer surface of the brake rotor to form a boride layer, and then steam-heating (steam treatment) the outer surface of the brake rotor with gaseous steam. Upon cooling, a steam-treated layer is formed over the boride layer on the outer surface and is comprised of iron oxide (Fe3O4) or magnetite. As a result, the outer surface has enhanced corrosion resistance, hardness, density and magnetic properties. Additionally, open pores on the outer surface are sealed for improved wear characteristics of the outer surface.

Reference will now be made in detail to several examples of the disclosure illustrated in the accompanying drawings. Whenever possible, the same or similar reference numerals are used in the drawings and the description to refer to the same or like parts or steps. The drawings are in simplified form and are not to precise scale.

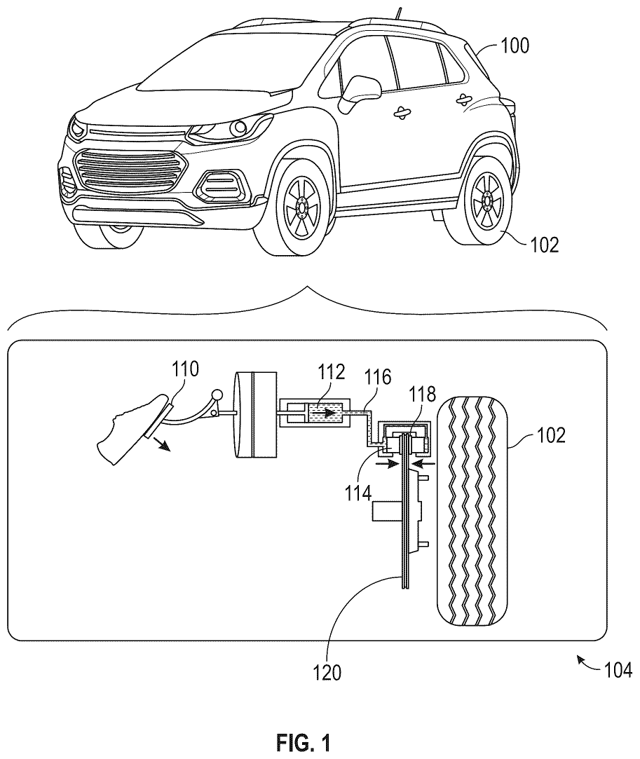

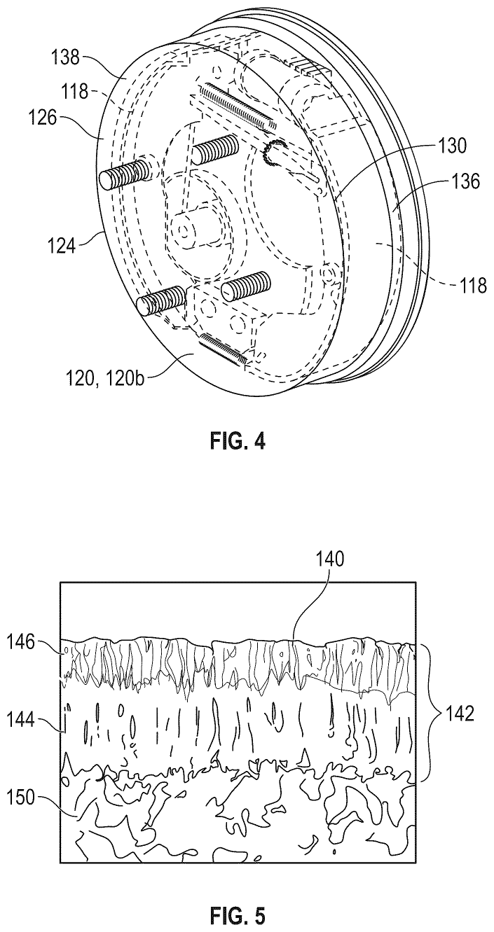

Referring now to FIG. 1, a vehicle 100 is illustrated and includes four wheels 102. Associated with one or more wheels 102 is a braking system 104. The braking system 104 generally includes a brake actuator 110, such as a brake pedal or an electronic brake actuator. The brake actuator 110 is connected to the master cylinder 112. The master cylinder 112 is connected to pistons 114 or wheel cylinders (see FIG. 4) associated with each wheel 102 by hydraulic lines 116. The pistons 114, or wheel cylinders, are connected to the brake pads 118, which are engageable with the brake rotors 120 connected to each wheel 102 when actuated by the brake actuator 110. The illustrated brake rotor 120 is a disc rotor; however, a drum rotor may alternatively be used (see FIG. 4).

Actuating the brake actuator 110, such as depressing the brake pedal or engaging an electronic brake actuator, generates pressure in the master cylinder 112. The pressure is transmitted hydraulically through hydraulic lines 116 to a piston 114, such as a disc brake piston or a wheel brake cylinder (in the case of drum brakes), associated with each braking system 104 and brake rotor 120. The pressure causes the pistons 114 to expand and the brake pads 118 to engage and apply a force against the brake rotor 120. The force slows the rotation of the brake rotor 120 and wheel 102 to which it is connected, eventually halting the rotation of the wheel 102.

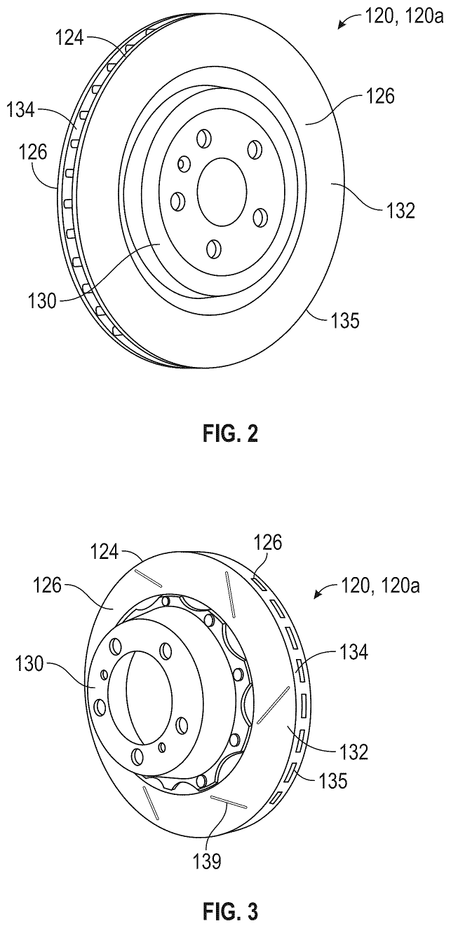

FIG. 2 illustrates a brake rotor 120 and, specifically, a disc brake rotor 120a. The disc brake rotor 120a includes a rotor body 124, which includes one or more braking surfaces 126 defining an annulus 132 on the rotor body 124 around a central hub 130. The central hub 130 being a circular hat or bell shape. While only a first braking surface 126 is illustrated in FIG. 2, a second braking surface 126 is present on the opposite side of the rotor body 124. The braking surface 126 may have a surface finish that varies 2 micrometers or less, such as from 0.3 micrometers to 2 micrometers.

The rotor body 124 may be formed from a ferrous metal, such as cast iron, which is an iron alloy that contains from 2 percent by weight to 4 percent by weight carbon of the total weight of the cast iron alloy along with 1 percent by weight to 3 percent by weight silicon of the total weight of the cast iron alloy. In embodiments, the cast iron is gray cast iron and carbon is present the form of graphite. The cast iron may also contain less than 1.0 percent by weight of the total weight of the cast iron alloy manganese, such as from 0.5 percent to 0.9 percent as well as trace amounts of sulfur and phosphorous impurities, also at less than 0.3 percent by weight of the total weight of the alloy. It is noted that the total weight of the cast iron alloy is 100 percent weight. Alternatively, the rotor body 124 may be formed from one or more alternative iron alloys such as compact graphitic iron (CGI), ductile iron (nodular iron), and steel, or from another suitable ferrous metal.

FIG. 3 illustrates a brake rotor 120, also a disc brake rotor 120a, in which the central hub 130 and surrounding annulus 132 of the rotor body 124 are formed from two separate components instead of a single component. In aspects, the central hub 130 is formed from a second material, including one or more metals, metal alloys, and ceramics. In embodiments, the central hub is formed of aluminum or an aluminum alloy and the annulus 132 surrounding the central hub 130 is formed from a ferrous metal, such as cast iron or an alternative iron alloy as described above. The central hub 130 is connected to the annulus 132 by one or more mechanical fasteners or fittings.

Further, the annulus 132 of the rotor body 124 may include a plurality of vents 134 extending from the center of the rotor body 124 to the edges 135 of the disc brake rotor 120a as illustrated in FIGS. 2 and 3, or through-bores defined between the braking surfaces 126 (not illustrated). In addition, the annulus 132 of the rotor body may include grooves 139 in the braking surfaces 126 (as illustrated in FIG. 3) or through holes defined in and extending through the rotor body 124 from braking surface 126 to the opposing braking surface.

FIG. 4 illustrates an embodiment of a brake rotor 120 and, specifically, a drum brake rotor 120b. The drum brake rotor 120b includes a rotor body 124 in the general form of a drum including a center hub 130 and a wall 136 extending from the center hub 130. At least a portion of the inner surface 138 of the wall 136 includes the braking surface 126. As with a disc brake rotor 120a, the rotor body 124 is formed from a ferrous metal, such as cast iron, which is an iron alloy that contains from 2 percent by weight to 4 percent by weight carbon along with 1 percent by weight to 3 percent by weight silicon. In embodiments, the cast iron is gray cast iron and carbon is present the form of graphite. The cast iron may also contain less than 1.0 percent by weight manganese, such as from 0.5 percent to 0.9 percent as well as trace amounts of sulfur and phosphorous impurities, also at less than 0.3 percent by weight. Alternatively, the rotor body 124 may be formed from one or more alternative iron alloys such as compact graphitic iron (CGI), ductile iron (Nodular Iron), and steel, or from another suitable ferrous metal.

As shown in FIG. 5, in embodiments herein, the braking surfaces 126 in any of the above described embodiments and aspects are boronized, i.e., surface treated with boron, wherein boron atoms are diffused into the surface 140 and subsurface (just below the surface 140) of the rotor body 124 to form an iron boride layer 142 over the iron alloy 150.

The iron boride layer 142 may include one or more types of iron borides. As used herein, the term “iron monoboride” refers to the iron boride having the FeB chemical composition and the term “diiron boride” refers to the iron boride having the Fe₂B chemical composition. Both iron monoboride (FeB) and diiron boride (Fe₂B) are harder than the ferrous metal. Iron monoboride (FeB) is harder than diiron boride (Fe₂B), but is more brittle and more easily fractured.

In certain embodiments, the only iron boride compound in the iron boride layer 142 is in the form of Fe₂B phases 144. Phases are understood as physically homogenous state of matter, having a certain chemical composition and distinct type of atomic bonding and arrangement of elements. In certain embodiments, the iron boride layer 142 may also include iron boride in the form of FeB phases 146 as illustrated in FIG. 5. Further, if graphite phases are present in the iron alloy, such as in gray cast iron, graphite phases may also be present in the iron boride layer 142. In addition, ferrous metal phases, such as iron phases, or other phases, may also be present in the iron boride layer 142, depending on the iron alloy the rotor body 124 is formed from and whether the iron alloy surface was previously treated using one or more of the treatments noted below.

The Fe₂B phases 144 develop first and penetrate deeper in the iron boride layer 142 than the FeB phases 146. Stated another way, when present, at least 60 percent by volume FeB phases are located closer to the surface 140 then Fe₂B, which are generally deeper in the iron boride layer 142. A crack may develop between the phases Fe₂B and FeB phases. The FeB phases 146 are prone to spalling, and the FeB phases 146 may spall off or be removed using a machining process as described further herein.

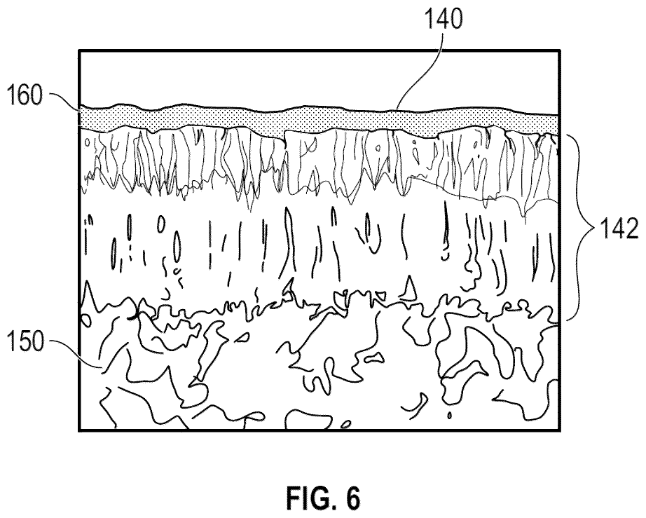

As shown in FIG. 6, in embodiments herein, the braking surfaces 126 in any of the above described embodiments and aspects are further treated to form an iron oxide layer 160 over the iron boride layer 142. The iron boride layer 142 may include Fe₂B phases 144 and FeB phases 146 or may include only Fe₂B phases 144. For example, processing may controlled to form only Fe₂B phases 144, or FeB phases 146 may be formed and removed before treatment to form the iron oxide layer 160.

A thermal process such as a steam treatment may be performed to create the iron oxide layer 160 as the surface 140 of the braking surface 126. Steam treatment provides the outer surface 140 with increased corrosion resistance, hardness, density and magnetic properties. Additionally, steam treatment can also be used to seal any open pores of the iron boride layer 142 or iron alloy 150 and improve wear characteristic of the outer surface 140. Steam treatment may be a batch process. As steam is introduced in a steam furnace, water vapor reacts with the iron of the iron boride layer 142, or of the iron boride layer 142 and iron alloy 150, to form the steam-treated layer 160, comprised of iron oxide or magnetite (Fe₃O₄). After a designated period of time, the brake rotor 120 is removed from the unit and allowed to cool as discussed below.

In certain embodiments, the stream treatment involves heating the brake rotor 120 with steam to a temperature of from 315° C. to 540° C. (600° F. to 1000° F.) for a time of from 0.5 hour to 3 hours to form the steam-treated layer 160 comprising iron oxide on the outer surface 140 and filling in open pores. In one embodiment, the brake rotor 120 may be heated to a temperature of from 370° C. to 480° C. (700° F. to 900° F.) in a steam furnace. For example, the brake rotor 120 may be heated to 425° C. (800° F.). Moreover, the time to heat the brake rotor 120 in the steam furnace may be from 1 hour to 2 hours, for example 1.5 hours.

In one embodiment for efficiency and throughput, a steam treat process may utilize a continuous belt steam-treat furnace having a temperature of from 315° C. to 370° C. (600° F. to 700° F.). Throughput may depend on the thickness of the iron oxide layer 160 as desired and may be from a time period of 0.5 hour to 3 hours. It is to be understood that other suitable temperature and time ranges may be used without departing from the spirit or scope of the present disclosure.

As pores and porosity have been known to become local corrosion initiation sites, implementation of methods herein provide corrosion prevention and resistance. As shown in FIG. 6, the steam-treated layer 160 is formed on the outer surface of the brake rotor and in the pores to minimize moisture and hence corrosion. In certain embodiments, the steam-treated layer 160 is comprised of iron oxide (e.g., Fe₃O₄) and has a thickness of from 10 to 50 microns for enhanced wear and corrosion resistance. In accordance with other embodiments, the thickness of the steam-treated layer 160 may be from 20 microns to 30 microns, for example 25 microns.

As previously noted, the rotor body 124, including the braking surface 126, may be treated with other surface treatments including one or more of the following processes: flame hardening, induction hardening, and laser hardening. Additionally or alternatively, the rotor body 124, including the braking surface 126, may be treated by one or more of the following processes: laser clad with an additional iron alloy, austenitic carburizing, nitriding, nitrocarburizing, and ferritic nitrocarburizing. Such treatments may be applied before or after boronizing and oxidizing the breaking surface 126. These treatments may affect the composition of the iron boride layer 142 and/or oxide layer 160.

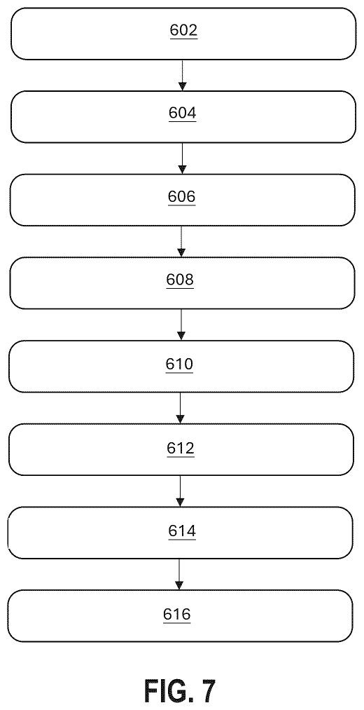

FIG. 7 illustrates a method 600 for forming a corrosion resistant product, such as a brake rotor. As shown, method 600 includes forming an initial member for processing at block 602. For example, method 600 may include forming the initial member through a process that may include melting and pouring a molten iron alloy into a mold or using additive manufacturing of an iron alloy feedstock. Once formed, molded-in stresses may be relieved by applying one or more of heat and pressure to the iron alloy. Further, the initial member may be machined.

At block 604, at least surfaces of the initial member are cleaned. For example, the braking surfaces 126 of the rotor body 124, and optionally the entire rotor body 124, may be cleaned to remove contamination such as debris, residue, oil, and oxides that may inhibit the diffusion of boron into the braking surface 126 and the development of iron boride compounds in the braking surfaces 126. Cleaning may be facilitated by using a solvent and/or water. Additionally, or alternatively, the rotor body 124 may be immersed in an acid bath. In embodiments, the cleaning methods selected do not alter the surface finish of the braking surfaces 126 of the rotor body 124, which may vary from 5 micrometers or less, such as 0.3 micrometers to 2 micrometers.

Block 606 includes boronizing the initial member. Specifically, at block 606, the braking surface 126, and optionally the entire rotor body 124, may be boronized. Boronizing may be carried out using at least one of the following treatment processes: boost-diffuse gas boriding, powder pack boriding, and phase homogenization in electrochemical boriding. During boronizing, boron or a boron containing composition is contacted with the iron alloy exposed to a temperature of 700° C. or greater, such as from 750° C. to 1000° C. In an embodiment of boost-diffuse gas boriding, the iron alloy is exposed to a boron containing gas at temperatures of from 800° C. to 950° C. This process may also be plasma assisted. In an embodiment of powder pack boriding, an iron alloy is packed in a powder mixture of boron carbide (B₄C), an inert filler such as SiC, and an activator such as KBF₄, and allowed to soak in an inert environment, furnace at a temperature of from 950° C. to 1000° C. In an embodiment of phase homogenization in electrochemical boriding, iron alloy is exposed to an electrolyte of molten borax and sodium carbonate at elevated temperatures of from 900° C. to 1000° C. It may be appreciated that the boronizing process may be used to relieve stress in the rotor body 124 and the step of relieving stress in the forming process may be omitted.

In the processes described above, Fe₂B phases develop first followed by the FeB phases. Current is applied to the iron alloy for a period of time, usually less than an hour. Fe₂B and, if present, the FeB phases are developed in the iron boride layer 142 formed under the surface 140 of the braking surface 126. The process selected may be adjusted to limit or prevent FeB phase development. As boronizing processes occur at elevated temperatures, after boronizing at block 604, at block 608 the rotor body 124 is allowed to cool to ambient temperatures, such as from 18° C. to 30° C., including all values and ranges therein, while holding the rotor body 124 in an environment at a temperature of from 18° C. to 30° C. Natural cooling may minimize warpage and distortion of the rotor body 124; however, some distortion may not be prevented.

At block 610, the braking surface 126 is mechanically finished to desired tolerances. Mechanical finishing at this stage may remove all, or at least a portion, of the FeB phases that may be present in the iron boride layer 142 as well as reducing variations that may have been imparted by the boronizing process. In embodiments, the braking surface 126 is mechanically finished to tolerances of +/−0.7 mm or less, including all values and ranges therein such as +/−0.5 mm or +/−0.25 mm, prior to cleaning at block 604 and boronizing at block 606 and then mechanically finished again so as to reduce variations imparted by the boronizing process. Various techniques may be used to mechanically finish the braking surfaces, including one or more of the following: precision milling and grinding, such as double disc grinding. In addition, if not already formed, the rotor body 124 may be drilled or slotted.

If other treatments are performed, including one or more of the following processes:
flame hardening, induction hardening, laser hardening, laser clad with an additional iron alloy, austenitic carburizing, nitriding, nitrocarburizing, and ferritic nitrocarburizing, the treatments may be applied before or after boronizing the breaking surface 126 at block 604, but prior to the machining at block 610.

In embodiments, the resulting brake rotor 120 may exhibit an iron boride layer 142 including Fe₂B having a thickness or depth of from 0.02 millimeters to 2.5 millimeters, including all values and ranges therein. Additional phases present in the iron boride compound layer may include one or more of iron, graphite, and FeB. Further, the boronized surface of Fe₂B phases may exhibit a hardness that is greater than the underlying iron alloy. The hardness of the braking surfaces may be from 1500 to 2000 HV. 01 (Vickers Hardness) as measured by ISO 6507-1:2018; whereas gray cast iron, for example, may exhibit a hardness of from 180 to 250 HV. In addition, the boronized surface may exhibit greater wear resistance than the underlying iron alloy.

Method 600 continues at block 612 with forming the iron oxide layer 160 over the iron boride layer 142. For example, method 600 may heat (by way of steam treatment) the brake rotor 120 with gaseous steam to a temperature of from 315° C. to 540° C. (600° F. to 1000° F.) for from 0.5 hour to 3 hours to form a steam-treated layer 160 on the outer surface 140 and in open pores.

In one embodiment, the brake rotor 120 may be heated to a temperature of from 370° C. to 480° C. (700° F. to 900° F.) in a steam furnace. For example, the brake rotor 120 may be heated to 425° C. (800° F.). Moreover, the time to heat the brake rotor 120 in the steam furnace may be from 1 hour to 2 hours, such as 1.5 hour.

As discussed above, steam treatment of the brake rotor 120 creates an iron oxide layer 160 on the outer surface 140 thereof. Steam treatment provides the outer surface 140 with increased corrosion resistance, hardness, density and magnetic properties. Additionally, steam treatment can also be used to seal the open pores of the outer surface 140 and improve wear characteristic of the outer surface 140. Steam treatment may be a batch process. As steam is introduced in the steam furnace, water vapor reacts with the iron of the iron boride layer 142, or the iron boride layer 142 and iron alloy 150, to form the steam-treated layer 160 comprised of iron oxide or magnetite (Fe₃O₄). After a designated period of time, the brake rotor 120 is removed from the steam furnace and allowed to cool.

In another embodiment for efficiency and throughput, a steam treat process may utilize a continuous belt steam-treat furnace having temperature of from 315° C. to 370° C. (600° F. to 700° F.). Throughput may depend on the thickness of the iron oxide layer 160 as desired and may be from 0.5 hour to 3 hours. It is to be understood that other temperature and time ranges may be used without departing from the spirit or scope of the present disclosure.

As a result, the steam-treated layer 160 is formed on the outer surface 140 and is comprised of iron oxide (Fe₃O₄) or magnetite. The steam-treated layer 160 may have a thickness of from 10 to 50 microns for enhanced wear and corrosion resistance. In another example, the thickness of the steam-treated layer 160 is from 20 microns to 30 microns, such as 25 microns.

The steam-treated layer 160 is formed on the outer surface 140 and in open pores to prevent or minimize moisture that would otherwise form thereon. Thus, the steam-treated layer 160 helps to seal the outer surface 140 and open pores, providing enhanced wear and corrosion resistance to the brake rotor.

Furthermore, the method 600 includes 110 at block 614 cooling the brake rotor 120 to ambient temperature, defining the enhanced vehicular brake rotor. Cooling may be accomplished by a cooling unit. It is to be understood that the cooling unit may be any designated unit or area arranged to allow the brake rotor 120 to cool to ambient temperature. For example, the brake rotor 120 may manually or robotically be disposed in a cooling bin after steam heating. After cooling, the brake rotor 120 may be moved to another area or unit for machining and/or inspection.

At block 616, the braking surfaces 126 are finished by polishing the braking surfaces 126.

Method 600 provides a product, such as an enhanced vehicular brake rotor, with improved wear and corrosion resistance. The resulting brake rotor 120 may be assembled into vehicle braking system or utilized in other braking applications as noted above.

In an embodiment, a method includes stress relieving rotor castings in a neutral atmosphere at a time and temperature adequate to reproduce the distortion which would have been generated in subsequent heat treat processes and machining or grinding the rotor/disc to the desired dimension (block 602); cleaning brake rotors/discs to ensure that they are free from contamination (i.e. oils, debris, residue, oxide) that may inhibit the boronizing (boriding) diffusion process (block 604); perform a boronizing (boriding) process (boost-diffuse gas boriding, powder pack boriding, PHEB phase homogenization electrochemical boriding) to cast iron components of the brake rotor/disc to facilitate boron diffusion and generate ultrahard diffused layer(s) of iron-boride compounds Fe₂B and/or FeB (block 606); cleaning rotors as required and cooling rotors to ambient temperature (block 608); machining/grinding rotor/disc to meet dimensional requirements and/or removing undesired FeB compound layer (block 610); heat treating the borided rotor with steam to form a protective oxide layer (steam treatment is performed on ferrous material by deliberate exposure to steam (H₂O) in a controlled and sealed heat-treating furnace at the temperature of from 315 to 540° C. (600 to 1000° F.) to form the oxide layer Fe₃O₄ (magnetite) on the surface (block 612); cooling the oxidized product (block 614), and finishing the product (block 616).

In certain embodiments, block 606 may include limiting or preventing dual-phase boride layer formation, because the single-phase design with only Fe₂B compound exhibits greater wear performance.

In certain embodiments the residual heat of the boronizing process (block 606) may be used to reduce the preheat energy needed in the steam treatment process (block 612). In such embodiments, the cooling process (block 608) may be skipped and the process for machining/grinding the borided rotor (block 610) may be skipped. Thus, using the residual heat of the boronizing process (block 606) in the steam treatment process (block 612) is facilitated by limiting or preventing dual-phase boride layer formation during the boronizing process (block 606), as machining to remove undesired FeB compound layer (block 610) is unnecessary if the formation of FeB phases is avoided or minimized. In order to use the residual heat of the boronizing process (block 606) to reduce the preheat energy needed in the steam treatment process (block 612), the boronized product may be quickly transferred to the steam treatment furnace while still heated from the boronizing process.

For example, when the steam treatment process is begun at block 612, the boronized product may already be at a temperature of 200° C. or greater, such as at least 250° C., at least 300° C., at least 350° C., at least 400° C., at least 450° C., at least 500° C., at least 550° C., at least 600° C., at least 650° C., at least 700° C., at least 750° C., at least 800° C., or at least 850° C., as a result of being heated from the boronizing process. Thus, the heat burden for the steam treating process is reduced.

Embodiments herein provide a boronized iron brake disc/rotor that utilizes a protective oxide layer (magnetite Fe₃O₄) for enhanced corrosion resistance. The methods herein are applicable to one-piece rotor designs, two-piece rotor designs, any cast iron rotor design, any additive manufactured iron rotor design, and to any combined rotor design of cast iron and additive manufacturing. Further, the processes described herein may be combined with other heat treatments processes such as induction, FNC, Carburizing, Nitrocarburizing, Nitriding, Austempering, or other suitable processing. Also, the processing described herein may be applied to any boronized ferrous component.

The oxidized and boronized brake rotor and brake systems of the present disclosure offer several advantages. These advantages include the formation of hardened and wear resistant braking surfaces. Further, the boronizing process may be used to replace the steps used to relieve stresses in casting. Also, heat from the boronizing process may be used to reduce heating necessary in the steam treating process. An additional advantage is that the braking surfaces of various forms of rotors, such as drum rotors, one-piece disc rotors, or two-piece rotors may be treated using the processes described above.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for forming a corrosion resistant product, the method comprising:
boronizing a surface of a ferrous metal component to form an iron boride layer on the surface; and
steam treating the ferrous metal component to form an iron oxide layer on the iron boride layer.

2. The method of claim 1, further comprising:
casting the ferrous metal component from a molten material to form a ferrous casting;
machining the ferrous casting to form a machined casting; and
removing contamination from the machined casting before boronizing the surface.

3. The method of claim 2, wherein boronizing includes contacting the ferrous metal component with a boron containing composition, wherein the ferrous metal component is exposed to a temperature of from 700° C. to 1000° C.

4. The method of claim 3, wherein steam treating is performed immediately after boronizing such that the ferrous metal component retains residual heat from the boronizing and is at a temperature of at least 200° C. when beginning the stream treating.

5. The method of claim 4, further comprising controlling boronizing conditions to minimize formation of iron monoboride (FeB) and promote formation of diiron boride (Fe₂B).

6. The method of claim 3, further comprising mechanically finishing the surface after boronizing.

7. The method of claim 6, wherein the iron boride layer includes iron monoboride (FeB) phases; and wherein mechanically finishing includes removing the iron monoboride (FeB) phases from the surface.

8. The method of claim 1, wherein steam treating the ferrous metal component to form the iron oxide layer on the iron boride layer comprises heating the ferrous metal component with gaseous steam to a selected temperature of from 315° C. to 540° C. for a duration of from 0.5 to 3 hours.

9. The method of claim 1, wherein the iron boride layer is formed with a thickness of from 0.02 millimeters to 2.5 millimeters, and wherein the iron oxide layer is formed with a thickness of from 10 microns to 50 microns.

10. A brake rotor comprising:
a ferrous metal body;
an iron boride layer on the ferrous metal body; and
an iron oxide layer on the iron boride layer, wherein the iron oxide layer forms a corrosion-resistant braking surface.

11. The brake rotor of claim 10, wherein the iron oxide layer is a magnetite oxide layer.

12. The brake rotor of claim 10, wherein the iron oxide layer has a thickness of from 10 to 50 microns.

13. The brake rotor of claim 10, wherein the iron oxide layer has a thickness of from 20 to 30 microns.

14. The brake rotor of claim 10, wherein the iron boride layer comprises a layer of diiron boride (Fe₂B) phases.

15. The brake rotor of claim 10, wherein the iron boride layer comprises diiron boride (Fe₂B) phases and iron monoboride (FeB) phases.

16. The brake rotor of claim 10, wherein the iron boride layer consists of diiron boride (Fe₂B) phases.

17. The brake rotor of claim 10, wherein the iron boride layer has a thickness of from 0.02 to 2.5 millimeters.

18. A vehicle comprising:
a propulsion system configured to provide motive torque to wheels; and
a braking system for braking rotation of the wheels, wherein the braking system comprises a brake rotor, and wherein the brake rotor comprises:
a ferrous metal body having an outer surface;
an iron boride layer formed on the outer surface of the ferrous metal body, wherein the iron boride layer comprises diiron boride (Fe₂B) phases, and wherein the iron boride layer has a thickness of from 0.02 millimeters to 2.5 millimeters,
an oxide layer formed on the iron boride layer, wherein the oxide layer is a magnetite oxide layer, wherein the iron boride layer has a thickness of from 10 microns to 50 microns; and wherein the iron oxide layer forms a corrosion-resistant braking surface.

19. The vehicle of claim 18, wherein the iron boride layer consists of Fe₂B phases.

20. The vehicle of claim 18, wherein the iron boride layer comprises the diiron boride (Fe₂B) phases and iron monoboride (FeB) phases.
